(19) United States
(12) Patent Application Publication
(10) Pub. No.: US 2017/0153666 A1
(43) Pub. Date: Jun. 1, 2017

(54) Bag computer vertical operating position holder

(71) Applicant: Charles Augustus Daley, III, T. Karon (TH)

(72) Inventor: Charles Augustus Daley, III, T. Karon (TH)

(21) Appl. No.: 15/330,221

(22) Filed: Aug. 26, 2016

Related U.S. Application Data
(63) Continuation-in-part of application No. 14/999,009, filed on Mar. 17, 2016.
Application No. 14/999,009 is a continuation-in-part of application No. 14/998,517, filed on Jan. 13, 2016.
Application No. 14/998,517 is a continuation-in-part of application No. 14/757,169, filed on Nov. 30, 2015.

(51) Int. Cl. G06F 1/16; A45C 11/00

(52) U.S. Cl. CPC G06F 1/1628; G06F 1/1626; G06F 1/1643; A45C 11/00; G06F 1/1681; A45C 2011/003

(57) ABSTRACT

Disclosed is a bag using a flexible fabric attachment flap as a hinge to pivotally attach the display panel to the outside top front area of the bag. For holding a display panel angle relative the bag front, the flexible fabric hinge includes a free section allowing an extension of the display panel to be used as a prop to hold the panel's angle. So that the display panel may be viewed by the bag wearer over the top end of the bag (vertical operating position) the bag may include a holder, for example an elastic band, to hold the bottom end of the display panel in a vertical position for viewing. The bag may include an operator body interface at the bag's bottom to stabilize the bag on the operator's body front and hold the display panel in viewing position.

### TECHNICAL FIELD

The present invention relates to a computer display designed for mobile use.

### BACKGROUND OF THE INVENTION

A bag including computer components was described in applications Ser. No. 12/216,650 (filed Jul. 9, 2008), Ser. No. 11/796,920 (filed May 1, 2007) and Ser. No. 11/799,011 (filed May 1, 2007). It included a display panel mounted to the bag with a flexible fabric attachment flap and an arrangement for propping the display panel into an operating position. Applications Ser. No. 12/927,884 (filed Nov. 30, 2010), Ser. No. 13/135,446 (Jul. 7, 2011) and Ser. No. 13/374,252 (Dec. 19, 2011) all included information about a display panel propping arrangement including a flexible fabric display panel mount that included a “free section”, a section of material between the bag and display panel, that is used in conjunction with a prop formed as a attachment edge extension of the display panel. This propping arrangement was further adapted to use in a “vertical operating position” (display panel pivoted upright and viewable by the bag wearer from over the top end of the bag) in application Ser. No. 14/121,914 (filed Nov. 3, 2014). In a further adaptation to the use of a display panel carried on a bag and viewable over the top end of the bag, applications Ser. No. 14/121,914 (filed Nov. 3, 2014) and Ser. No. 14/757,169 (filed Nov. 30, 2015) show an “operator body interface”, an adaptation of the bottom end of the bag to facilitate the holding the bag to the operator while propped on the operator's body front with the display panel viewable over the top end of the bag and approximately in front of the operator's view (vertical operating position). These various adaptations may be seen as unique inventions and improvement or as new inventions in their unusual and new utility producing combinations.

For the purpose of making a simpler and more rugged bag computer, a display panel with extension prop and no moving parts may be used in conjunction with a vertical operating position holder (e.g. a lateral elastic band) along with an bag bottom operator body interface that may be better used to regulate the display angle than a more complicated display panel prop.

### BRIEF DESCRIPTION OF THE INVENTION

Sheet 1: The components and operation principles of a bag computer are explained. In particular, the storage position (parallel against the bag front) and operating positions (for example, approximately perpendicular the bag front for downward viewing or a vertical operating position with the display panel parallel to the bag front but above the bag top and viewable over the top end area of the bag) of the display panel on the bag are shown with the orientation for use.

Sheet 2: The display panel may be removable from the bag. The display panel may be configured to attach to the bag using a flexible fabric attachment flap that acts as a hinge. For example, the display panel may include one or more jaws to hold the free section (e.g. for clamping). The display panel may include an extension prop. This prop may be used along with the attachment flap to hold the display panel in various angles relative to the bag front wall.

Sheet 3 Side view magnified views of the bag near the connection of the bag and display panel show more detail about how the display panel with attachment flap (hinge) may hold angles relative to the bag front. The display panel may be configured to attach to the bag using a flexible fabric attachment flap that acts as a hinge. The attachment flap may be or include a free section (attachment flap) a type of attachment flap that has a section of flap between the bag and the display panel. The free section may pivot parallel to the junction of the front and top panels 1) at the bag and 2) at the display panel. In a storage position the display panel may hang parallel to the bag front. In an operating position approximately perpendicular to the bag front the free section suspends (stays) the display panel while the extension prop of the display panel pushed against the bag front. Together they hold the angle of the display panel for viewing.

Sheet 4 and 5 For a vertical operating position, the display panel, near its attachment edge and the extension prop may be inserted downward into a vertical operating position holder which holds the display panel approximately parallel to the bag front wall and viewable over the top end area of the bag. The operating position approximately perpendicular to the bag front and the vertical operating position may be seen in a perspective drawing.

Sheet 6 It may be seen that the free section (attachment flap hinge) and the vertical operating position holder may extend laterally (right side to left side) across the bag near the junction of the top and front walls. The vertical operating position holder is attached to the bag in a direction downward from the attachment of the free section to the bag.

Sheet 7 There may be various types of vertical operating position holders and a few may be specified. It may include a contact surface for improving the traction of the extension prop end to the bag. It may include a bottom end to form a pocket; may be shaped and/or have more than one display panel holding parts; may be a band with an opener and/or a length adjuster; may be made partially or entirely of elastic.

Sheet 8 The bag computer may be shown worn by an operator showing how the operator may wear, operator, manipulate and view the bag and display while in a vertical operating position. To facilitate using the bag computer in a vertical operating position, the bag may further include an operator body interface designed to temporarily hold the bottom end area of the bag to the operator's front body surface. The operator body interface may include various features to stabilize the bag on the operator in terms of tipping and sliding.

Sheet 9 The operator body interface of the bag computer may work to provide stability of the display and bag on the operator body front by including a laterally stability member with a right laterally separated surface and a left laterally separated surface to keep the bag from tipping to the right or to the left. The operator body interface may include an operator linking attachment or a friction enhancing feature to provide sliding stability in all direction. The operator body interface may include a lateral pivot axis to allow the bag to pivot in a front to back direction or back to front direction from the operators face to adjust viewing distance.

### BRIEF DESCRIPTION OF THE SEVERAL VIEWS OF THE DRAWINGS

FIG. 1A This shows the bag computer with the display panel in a storage position and the cover open to expose the computer equipment storage area.

FIG. 1B This shows the bag computer with the display panel in an operating position with the display viewable by a wearer/operator from above looking downward.

FIG. 1C This shows the back side of the bag computer.

FIG. 1D This shows the bag computer with the display panel in a vertical operating position with the display viewable by a wearer/operator from in back of the bag and looking back to front across the top end area of the bag.

FIG. 1E This figure defines planes related to the display panel, the front wall and the top wall.

FIG. 2A This shows the front side of the display panel pivotally and removably attachable to the bag computer.

FIG. 2B This shows a side (profile) view of the display panel of FIG. 2A.

FIG. 2C This shows a back side view of the display panel of FIG. 2A and including various controls, attachments and connections.

FIG. 3A This is a right side view of the display panel attached to the bag near the junction of the top wall and the front wall. The display panel is attached with a pivoting computer equipment mount including a free section flexible fabric hinge and is in a storage position parallel to the bag front wall.

FIG. 3B This shows a magnification of the circled area in FIG. 3A.

FIG. 4A This is a right side view of the display panel attached to the bag near the junction of the top wall and the front wall. The display panel is attached with a pivoting computer equipment mount including a free section flexible fabric hinge and Is in an operating position viewable by the operator from above looking downward.

FIG. 4B This shows a magnification of the circled area in FIG. 4A.

FIG. 5A This is a right side view of the display panel attached to the bag near the junction of the top wall and the front wall. The display panel is attached with a pivoting computer equipment mount including a free section flexible fabric hinge and is in the process of being installed into a vertical operating position.

FIG. 5B This shows a magnification of the circled area in FIG. 5A.

FIG. 6A This is a right side view of the display panel attached to the bag near the junction of the top wall and the front wall. The display panel is attached with a pivoting computer equipment mount including a free section flexible fabric hinge and is in a vertical operating position with the display panel held approximately parallel to the bag front wall by the vertical operating position holder.

FIG. 6B This shows a magnification of the circled area in FIG. 6A.

FIG. 7A This shows a magnified view of the circle labeled “130” in FIG. 1B. It shows more detail of the pivoting computer equipment mount using a free section and display panel extension prop. The display panel is in an operating position.

FIG. 7B This shows a magnified view of the circle labeled “131” in FIG. 1D. It shows more detail of the pivoting computer equipment mount using a free section and display panel extension prop. The display panel is in an vertical operating position using a vertical operating position holder.

FIG. 8 This shows the upper part of the computer bag (the lower part is cut off). The display panel is removed to better show the free section and the vertical operating position holder.

FIG. 9A This is, removed from the bag, the vertical operating position holder used to hold the display panel in a vertical operating position. It is shown here including a contact surface to help hold the extension prop end in place on the bag.

FIG. 9B This is, removed from the bag, the vertical operating position holder used to hold the display panel in a vertical operating position. It is shown here with a bottom to make the structure pocket-like.

FIG. 9C This is, removed from the bag, the vertical operating position holder used to hold the display panel in a vertical operating position. It is shown here shaped to make more than one bands, sockets or pockets to hold display panel leg props.

FIG. 9D This is, removed from the bag, the vertical operating position holder used to hold the display panel in a vertical operating position. It is shown here as a band which may include fixtures to open the band or to adjust the band's length.

FIG. 9E This is, removed from the bag, the vertical operating position holder used to hold the display panel in a vertical operating position. It shows that the band may partially or completely made of elastic material to allow the band to contract or expand.

FIG. 10A This shows an operator wearing the bag computer and using it with the display panel in a vertical operating position. The bag bottom end area is attached to the operator's belt.

FIG. 10B This shows an operator wearing the bag computer and using it with the display panel in a vertical operating position. The bag bottom end area is held to the operator's chest using the bag's operator body interface with a friction enhancing feature.

FIG. 11A This is the bag computer with more detail about the operator body interface in the bag bottom end area.

FIG. 11B This is the bag computer in a storage position with the pivoting cover covering the computer equipment storage area.

FIG. 12 This shows an operator and wearer of the bag computer demonstrating the stability characteristics as shown in a front view (facing the reader).

FIG. 13 This shows an operator and wearer of the bag computer demonstrating the stability characteristics as shown in a side view (operator profile).

### DETAILED DESCRIPTION OF THE INVENTION

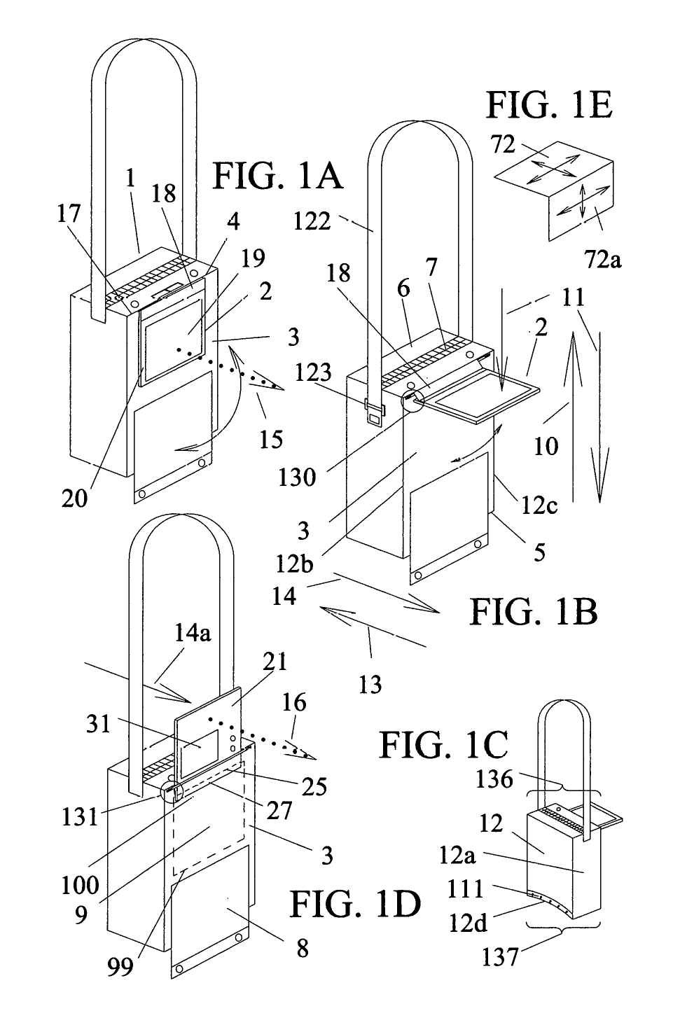

FIG. 1A, 1B, 1C, 1D and 1E show a bag computer including a bag 1 and a display panel 2. The bag may have several walls (the outside surfaces of all walls are shown) a front wall 3 (here showing the outside surface) which may have a top edge 4 and a bottom edge 5. At the top of the bag there may be a top wall 6 which may include an opening 7 for accessing the bag interior (here shown with a zipper closure). The bag, for example the front wall, side walls, top wall, bottom end, top end or back wall, may have a right side 12b and/or a left side 12c. The bag may include a suspension device 122 (e.g. strap) and/or one or more suspension device attachment 123 (to attach a suspension device to the bag) for the purpose of carrying the bag and suspending the bag from the operator especially while the bag and display are in a vertical operating position. The bag may include a pivoting cover 8 pivotally attached to the bag (for example, the bag front wall) and configured to pivot and cover the computer equipment storage area 9 (shown in dashed line) on the outside surface of the bag front wall where the display panel is found when in a storage position (storage position shown in FIG. 1A). The computer equipment storage area includes a top end 100 and a bottom end 99. The pivoting cover may be pivotally attached to the bag near the bottom end of the computer equipment storage area.

There may be orientations relative to the bag. The bag has an upward 10 direction orientation which is toward the top of the bag, and a downward 11 direction orientation. Objects attached to the bag such as the display panel, front wall top edge or vertical operating position holder, may be positioned relative to each other as being in an “upward” direction or “downward” direction from another object or place on the bag. The bag may include a back wall 12 and a bag bottom end area 137 (shown in FIG. 1C), a wall at the bag bottom end and a bag top end area 136. The bottom end area may include the bottom wall, the junction of the bottom wall with other walls (for example, the junction of the back wall and the bottom wall 12d) and the area of adjacent walls near the bottom wall. In this figure, a portion of the operator body interface 111 is shown in the bag's bottom end area. Similarly, the top end area may include the top wall and junctions and areas near it. The bag may include an orientation of front to back direction 13 or back to front direction 14. Objects attached to the bag such as the display panel or vertical operating position holder, may be positioned relative to each other as being in an “front to back direction” or “back to front direction” from another object or place on the bag. There is a plane 72 (FIG. 1E) called the “plane of the display panel” wherein this plane is a surface parallel to the display panel, this plane (72) showing the plane of the display panel in an operating position as shown in FIG. 1B. The plane of the display panel may change as the display panel is pivoted from/to the storage position to various operating positions (FIG. 1B, 1C, 1D). Similarly, there is a “plane of the bag front wall” 72a.

There may also be an orientation relative to the display panel. There may be an away from the display panel front side 20 direction 15 orientation (FIG. 1A, dotted arrow) and there may be an away from the display panel back side 21 direction 16 orientation (FIG. 1D, dotted arrow). This orientation applies no matter what position the display panel may be in. FIG. 1D also shows that a prop 27 may be included and is may be attached to or an extension of the display panel attachment edge 25. A pointing device, such as a touch pad 31, may be included on the display panel back side.

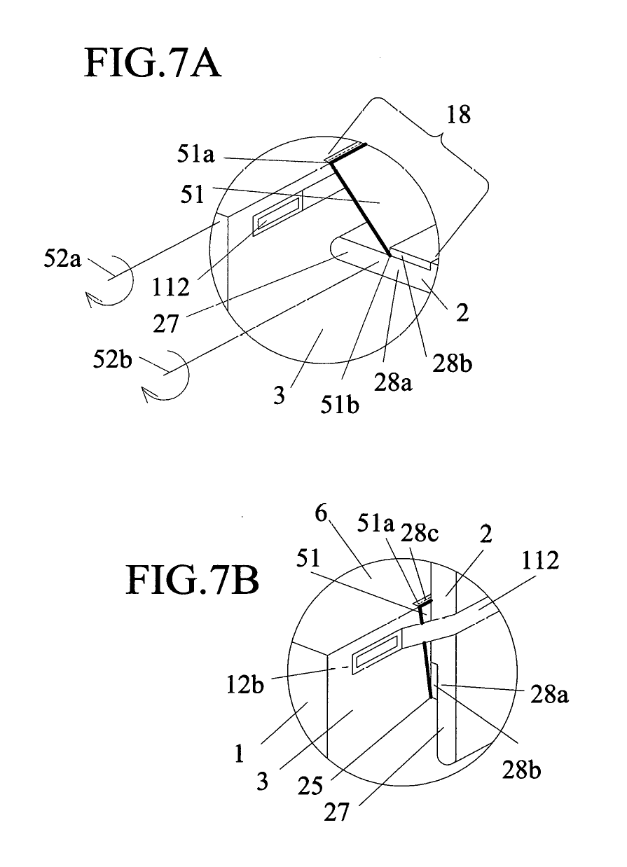

The bag may also include a display panel 2 which may be pivotally attached to the bag near the junction 17 of the top wall and front wall and the top edge of the front wall (for example, sewn to or riveted to or an extension of the top wall or the front wall or a side wall 12a (e.g. a side wall to the right or left side of the bag) near the junction of the top and front walls). The display panel may be attached to the bag using a pivoting computer equipment mount 18, which removably and pivotally attaches the display panel to the bag. In FIG. 1B a circle labeled 130 Indicates an area to be magnified in FIG. 7A. In FIG. 1D a circle labeled 131 indicates an area to be magnified in FIG. 7B.

The display panel includes an electronic display 19 (also or alternatively called “the display”) and may be moved into a storage position (shown in FIG. 1A) in the computer equipment storage area 9 next to and approximately parallel to the bag front wall. From that position the display panel may be pivoted into one or more operating positions (shown in FIG. 1B, 1C, and 1D) with the display facing and visible to the operator/wearer of the bag (for example with the operator viewing downward direction 11 in FIG. 1B). The operating position may be vertical operating position (shown in FIG. 1D) with the display panel plane approximately parallel to the bag front wall and the display viewable in a back to front direction 14a over the bag top end area. The vertical operating position may vary in somewhat angle relative to the bag front. Its purpose is to view the display from an angle extending over the bag top end area or bag top wall. This position is useful for using the bag to elevate the display from a surface it rests on, such as the operator's lap, chest or stomach. In this way viewing of the display may be facilitated.

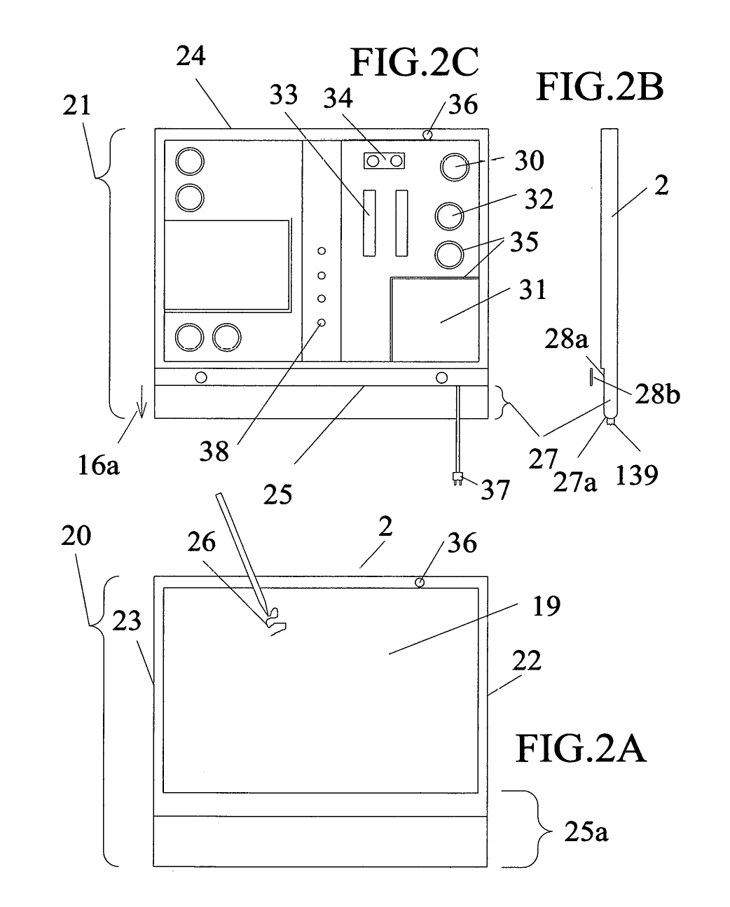

Shown in FIG. 2A, 2B, and 2C, the display panel 2 may be panel-like with a front side (shown as 20 in brace in FIG. 2A) which may include an electronic display 19 (also or alternatively called “the display”) and/or controls, a back side (shown as 21 in brace in FIG. 2C), a right side edge 22, a left side edge 23, a distal edge 24 and an attachment edge 25 (also or alternatively called the attachment edge or the attachment axis). The attachment edge is where the pivoting computer equipment mount attached and, as shown here, may not be the edge of the display panel. The attachment edge may also be called the attachment axis. The display panel may include a connection end 25a (shown by the brace) which may include the part of the display panel nearer its connection with the bag, for example, the extension prop, the attachment edge and the parts of the display panel near the attachment edge. In a vertical operating position, the display panel is held vertical and in the view of the operator (bag wearer) over the top end area of the bag by the display panel connection end held to the bag using a vertical operating position holder. The display may include a touch screen 26 (shown with stylus writing). The display panel may include one or more props, legs or extension prop 27 for assisting in holding the display panel at various operating positions relative to the bag front wall. The extension prop may be fixed to the display panel and may be immovable relative to the display panel. The extension prop is a part of the display panel and may be attached (or fixed) to the display panel near the attachment edge in a way so it extends the length of the display panel in a direction from the attachment edge opposite 16a the remainder of the display panel so that when in an operating position approximately perpendicular to the bag front wall the extension prop may extend between the bag front wall and the display panel attachment edge. The extension prop is in a front to back direction from the display panel attachment edge when the display panel is in an operating position approximately perpendicular to the bag front wall. The remainder of the display panel is in a back to front direction from the attachment edge when the display panel is in an operating position approximately perpendicular to the bag front wall. There may be more than one prop or there may be one continuous prop along the attachment edge of the display panel. In the case of one continuous prop, the prop may obscure the attachment edge. When thus obscured, the attachment edge may be called an attachment axis and is defined by the place on the display panel where the display panel connects to the bag and other parts of the pivoting computer equipment mount (for example a flexible fabric attachment flap and/or a free section).

The attachment edge may also be called an attachment axis in the case where the connection or attachment to the bag pivots where it attaches to the display panel. This may be the case where the attachment to the bag is at the right side edge and left side edge of the display panel with the attachment axis extending through the display panel between the two side attachment points.

Shown in side view FIG. 2B, the attachment edge may include an attachment such as one or more clamps, jaws 28a (first jaw) and 28b (second jaw), channels, tracks, rails, snaps, hooks, hook and loop or other attachment to connect the display panel 2 to the bag (i.e. a part of the pivoting computer equipment mount). The prop, as shown here, is an extension of the display panel which may include a prop end 27a which may include a gripping feature 139, such as a groove, teeth, projection, feature matching a contact surface, socket or elastomeric material, that is designed to help the extension prop end temporarily adhere to the bag front or to a contact surface.

In FIG. 2C, the back side of the display panel, the side of the display panel opposite the display, may include one or more controls 30 such as one or more touch pads 31, buttons 32, slides 33, switches 34 or other features to operate the display or a computer the display panel may attach to. The back side may include an electronic display. The controls may include one or more finger guides 35 around or near a control to guide an operator finger to the control and to protect the control from inadvertent activation. The display panel may include an input/output device such as a camera 36, antenna or communicator. The display panel may include other electronics such as computing unit, input/output devices, batteries, telephone, radio communication, etc. The display panel may include one or more electrical connection 37 to connect it with external electronics (e.g. a computer). The display panel may include display panel prop fixtures 38 for permanently or temporarily holding a display panel prop which holds the display panel at angles relative to the bag front.

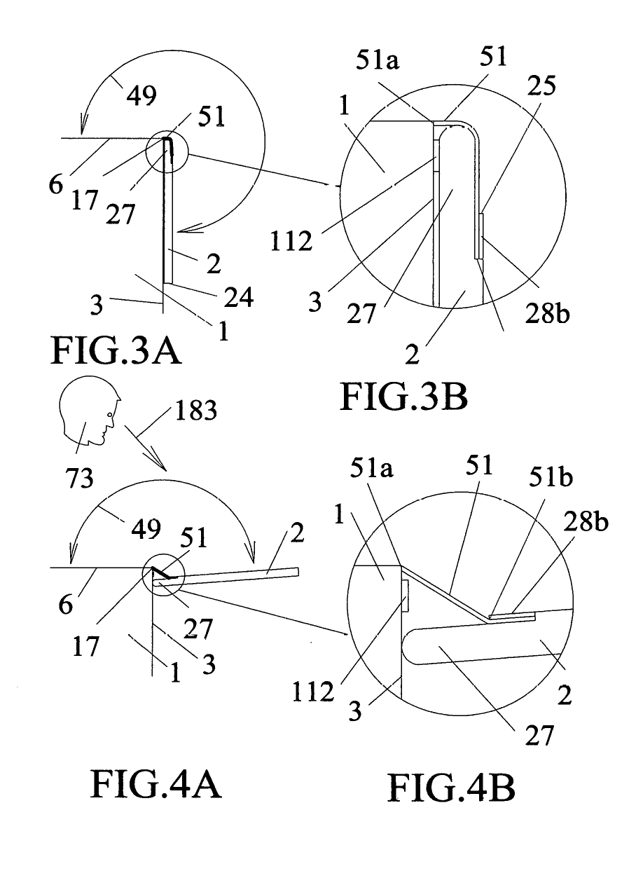

FIG. 3A, with the circled area magnified in FIG. 3B, show a partial view of the right side of the bag 1 showing the display panel 2 mounted to it near the junction 17 of the front wall 3 and top wall 6 (this junction may also be the top edge of the front wall). The display panel includes an extension prop 27 attached near the attachment edge of the display panel. The display panel attachment edge is shown attached to the bag using a free section 51 (shown with heavy line), a piece of flexible fabric such as one or more short flaps of bag material or other sheet-like material or one or more sections of line such as filament, electrical wire, cord or other linear material. The free section is a part of the pivoting computer equipment mount. Angle 49 shows the angle of the plane of the display panel relative to the plane of the bag top wall being held by the free section, display panel extension prop, and bag front wall angle holding arrangement. The angle relative to the plane of the front wall would be 270 degrees minus the angle (in degrees) of angle 49.

In FIG. 3B, a magnification of the circled area of FIG. 3A, the display panel is in a storage position approximately parallel to the bag front wall and in the computer equipment storage area on outside surface of the bag front wall. Because of the pivoting, in the storage position the display panel distal edge 24 is in a downward direction from the connection end. The free section proximal end 51a is attached to the bag 1 near the junction of the front wall 3 and the top wall (e.g. by sewing or riveting) and may pivot there on an axis parallel to the junction of the top wall and the front wall. The free section distal edge is attached at and pivots on the display panel 2 attachment edge 25, in this case clamped in the jaws (e.g. 28b) of the display panel. Notice that the free section 51, made of flexible material, extends around the extension prop 27 to the back to front direction side of the extension prop with the prop and display panel next to the front wall.

The vertical operating position holder 112 is shows between the display panel and the bag front wall and is positioned in a downward direction from the place of attachment of the free section (proximal end) to the bag. The vertical operating position holder may be located near the top end of the computer equipment storage area. The free section is in a back to front direction from the vertical operating position holder and the display panel. The vertical operating position holder may be made of a collapsible (contractible) and/or expandable material and is shown collapsed (e.g. elastic contracted) in this figure.

FIG. 4A, with the circled area magnified in FIG. 4B, show a partial view of the right side of the bag 1 showing the display panel 2 mounted to it near the junction 17 of the front wall 3 and top wall 6 (this junction may also be the top edge of the front wall). The display panel includes an extension prop 27 attached near the attachment edge of the display panel. The display panel attachment edge is shown attached to the bag using a free section 51 (shown with heavy line), a piece of flexible fabric such as one or more short flaps of bag material or other sheet-like material or one or more sections of line such as filament, electrical wire, cord or other linear material. The free section is a part of the pivoting computer equipment mount. Angle 49 shows the angle of the plane of the display panel relative to the plane of the bag top wall being held by the free section, display panel extension prop, and bag front wall angle holding arrangement. The angle relative to the plane of the front wall would be 270 degrees minus the angle (in degrees) of angle 49. An operator 73 wearing the bag is shown viewing 183 the electronic display in an approximately downward direction.

In FIG. 4B, a magnification of the circled area of FIG. 4A, shows the display panel in an operating position approximately perpendicular to the bag 1 front wall 3. The free section proximal end 51a is attached to the bag near the junction 17 of the front wall and top wall (e.g. by sewing or riveting) and, because it is a flexible material, may pivot at its attachment to the bag. The free section distal edge 51b is attached to the display panel, in this case clamped in the jaws (e.g. 28b) of the display panel and pivotable on the display panel 2 at the display panel's attachment edge. Notice that the free section, made of flexible material, extends from the bag to the display panel attachment edge and suspends (or stays) the display panel while the extension prop 27 pushes on and temporarily adheres to the bag front wall and positions the electronic display in an operating position at an angle in the view (line of sight) of the operator (bag wearer).

The vertical operating position holder 112 is shows attached to the outside surface of the bag front wall and is positioned in a downward direction from the place of attachment of the free section to the bag. The free section is outside of the vertical operating position holder (i.e. in a back to front direction from the vertical operating position holder). The vertical operating position holder may be made of a collapsible (contractible) and/or expandable material and is shown collapsed (e.g. elastic contracted) in this figure.

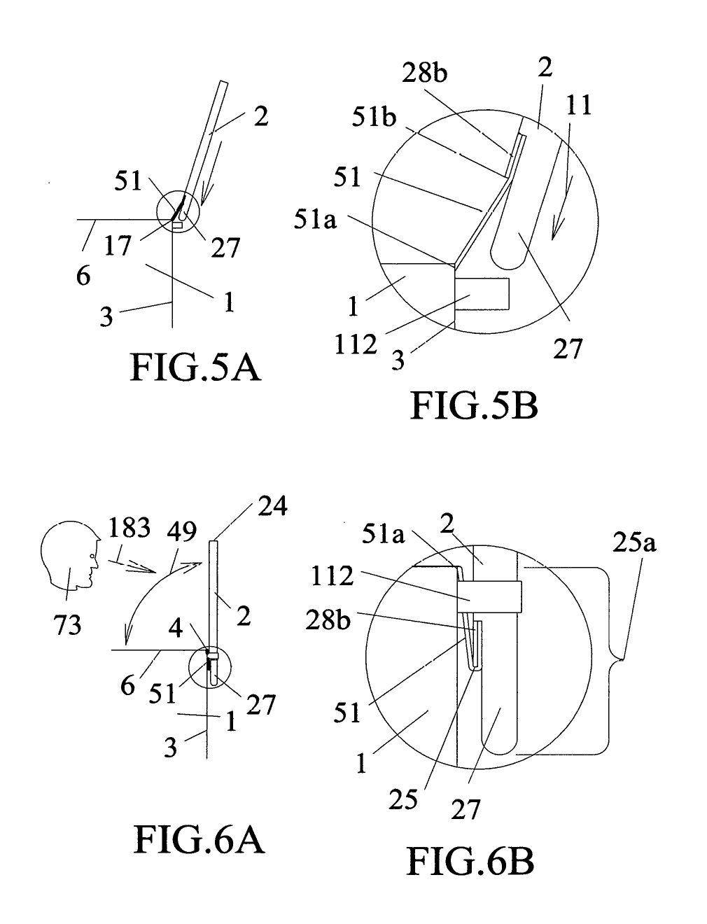

FIG. 5A, with the circled area magnified in FIG. 5B, show a partial view of the right side of the bag 1 showing the display panel 2 mounted to it near the junction 17 of the front wall 3 and top wall 6 (this junction may also be the top edge of the front wall). The display panel includes an extension prop 27 attached near the attachment edge of the display panel. The display panel attachment edge is shown attached to the bag using a free section 51 (shown with heavy line), a piece of flexible fabric such as one or more short flaps of bag material or other sheet-like material or one or more sections of line such as filament, electrical wire, cord or other linear material. The free section is a part of the pivoting computer equipment mount.

In FIG. 5B, a magnification of the circled area of FIG. 5A, the display panel is in an operating position. However, the extension prop 27 of the display panel 2 has been moved away from the bag 1 so that it can be inserted with a downward direction 11 movement into or through the vertical operating position holder 112 on the bag front. The vertical operating position holder is attached to the bag and located laterally across the front wall in a downward direction from the place of the free section's proximal end 51a attachment to the bag near the junction of the top wall and front wall 3 (e.g. by sewing or riveting). The vertical operating position holder may be located near the top end of the computer equipment storage area. The free section is attached to the bag so it may pivot on an axis parallel to the top edge of the front wall (junction of the top wall and the front wall) and the free section has enough length (bag to display panel direction) to flex and move as the display panel is inserted in back of the vertical operating position holder between the holder (shown as an elastic band) and the bag front wall. The vertical operating position holder may be collapsible (contractible) and/or expandable material and is shown expanded in this figure and ready to receive the display panel as the panel is moved in a downward direction into the vertical operating position holder.

The free section 51 distal edge 51b is attached to the display panel, in this case clamped in the jaws (e.g. 28b) of the display panel and pivotable on the display panel at and parallel to the display panel's attachment edge. Notice that the free section, made of flexible material, extends from the bag to the display panel attachment edge and the extension prop is attached to the display panel attachment edge.

FIG. 6A, with the circled area magnified in FIG. 6B, show a partial view of the right side of the bag 1 showing the display panel 2 mounted to it near the top edge 4 of the front wall 3. The display panel includes an extension prop 27 attached near the attachment edge of the display panel. The display panel attachment edge is shown attached to the bag using a free section 51 (shown with heavy line), a piece of flexible fabric such as one or more short flaps of bag material or other sheet-like material or one or more sections of line such as filament, electrical wire, cord or other linear material. The free section is a part of the pivoting computer equipment mount. Angle 49 shows the angle of the plane of the display panel relative to the plane of the bag top wall 6 being held by the free section, display panel extension prop, and bag front wall angle holding arrangement. The angle relative to the plane of the front wall would be 270 degrees minus the angle (in degrees) of angle 49. An operator 73 wearing the bag is shown viewing 183 the electronic display in a back to front direction over the bag top end area. It can be seen that, while in the vertical operating position, the display panel distal edge 24 is in an upward direction from the display panel connection end.

In FIG. 6B, a magnification of the circled area of FIG. 6A, the display panel 2 is in a vertical operating position approximately parallel to the bag front wall but extending above the top edge of the bag, front wall and viewable over the top end of the bag by an operator wearing the bag, in back of the bag and viewing the electronic display from a back to front direction. The free section proximal end 51a is attached to the bag 1 near the top edge of the front wall (e.g. by sewing) and, because it is a flexible material, may pivot at its attachment to the bag. The free section distal edge is attached to the display panel, in this case clamped in the jaws (e.g. 28b) of the display panel and pivotable on the display panel at the display panel's attachment edge 25. The free section 51, made of flexible material, extends from the bag to the display panel attachment edge. Notice that, in the vertical operating position, the free section is located between the display panel and the bag front wall (i.e. in a back to front direction from the bag front wall and in a front to back direction from the display panel) and the extension prop 27 is located downward from the display panel attachment edge.

The vertical operating position holder 112 is shows attached to the outside surface of the bag front wall and is positioned in a downward direction from the place of attachment of the free section to the bag. The vertical operating position holder may be located near the top end of the computer equipment storage area. It may be made of a collapsible (contractible) and/or expandable material and is shown expanded in this figure. When in use, the vertical operating position holder extends around both the display panel and the free section to hold the connection end 25a of the display panel to the bag and the display panel in an approximately vertical position parallel to the bag front wall and viewable by the operator/bag wearer over the top end area of the bag.

FIG. 7A is a magnification of the circle labeled 130 in FIG. 1B. It shows the area where the pivoting computer equipment mount 18 pivotally attaches the display panel 2 to the bag. This type of pivoting computer equipment mount includes a free section 51 (shown outlined in heavy lines), a piece of flexible fabric such as one or more short flaps of bag material or other sheet-like material (shown) or one or more sections of line such as filament, electrical wire, cord or other linear material. The free section is a portion of the pivoting computer equipment mount that extends between the bag and display panel. The proximal end 51a of the free section attaches to the bag (for example by sewing or riveting) and the distal end 51b attached to the display panel. Also included in this type of pivoting computer equipment mount is an attachment to removably attach the display panel to the free section, the attachment being, in this case, two jaws 28a (first jaw) and 28b (second jaw). In this type of pivoting computer equipment mount the free section, though it may be flexible throughout, pivots on one or more (usually two) axes parallel to the junction of the top wall and the front wall (and display panel attachment edge), for example, a first axis 52a associated with the proximal end of the free section near the junction of the bag top wall and the bag front wall and a second axis 52b associated with the distal end of the free section at the attachment edge of the display panel. Notice that the pivoting computer equipment mount may be somewhat longer (bag to display panel direction) than the free section due to the attachment features (clamp, sewing, etc.). The display panel may include a prop which can, along with the free section, regulate and hold an angle between the bag front wall and the display panel. In this case, the prop is an extension prop 27, an extension of the display panel.

In this figure, the display panel is in an operating position approximately perpendicular to the bag front wall (back to front direction and/or front to back direction from the bag front wall) and viewable by an operator from above and looking in a downward direction. The free section, a length of flexible material, in this case a sheet-like flap, suspends (or stays) the display panel while the extension prop pushes against and temporarily adheres to the bag front wall 3 and positions the electronic display at an angle in the view of the operator/wearer. The vertical operating position holder 112 is shown attached to the bag (right side end shown) but not being used and collapsed (contracted) against the bag front wall.

FIG. 7B is a magnification of the circle labeled 131 in FIG. 1D. It shows the area where the pivoting computer equipment mount pivotally attaches the display panel 2 to the bag 1. This is the same type of pivoting computer equipment mount shown in FIG. 7A. It includes a free section 51 (shown outlined in heavy lines), with proximal end 51a and distal end, attachment edge 25, two jaws, 28a (first jaw) and 28b (second jaw), for attachment to the display panel. The proximal end of the free section is shown attached (e.g. sewn 28c) to the top wall 6 of the bag. The display panel includes an extension prop 27 which can, along with the free section, regulate and hold an angle between the bag front wall and the display panel.

In this figure, though, the display panel is in a vertical operating position approximately vertical and parallel to the bag's front wall and viewable over the top end of the bag. The free section is extended downward parallel to the bag front wall from the bag to the display panel and located between the bag front wall 3 and the display panel.

Attached to the bag and located in a downward direction from the attachment place of the free section proximal end to the bag is a vertical operating position holder 112, a device for holding the display panel in the vertical operating position. The vertical operating position holder may be located near the top end of the computer equipment storage area. The vertical operating position holder, when in operation and holding the display panel connection end to the bag and the display panel in the vertical operating position may pass from the bag right side 12b around the free section and display panel connection end to the bag left side so it is positioned against the back side of the display panel in a back to front direction from the display panel. The vertical operating position holder is shown in FIGS. 7A and 7B as an elastic band attached to the bag on the band (holder) right end and left end and may collapse (contract) against the bag front wall (FIG. 7A) when not in use or expand away from the bag front wall (FIG. 7B) to install the display panel between the band and the bag for a vertical operating position.

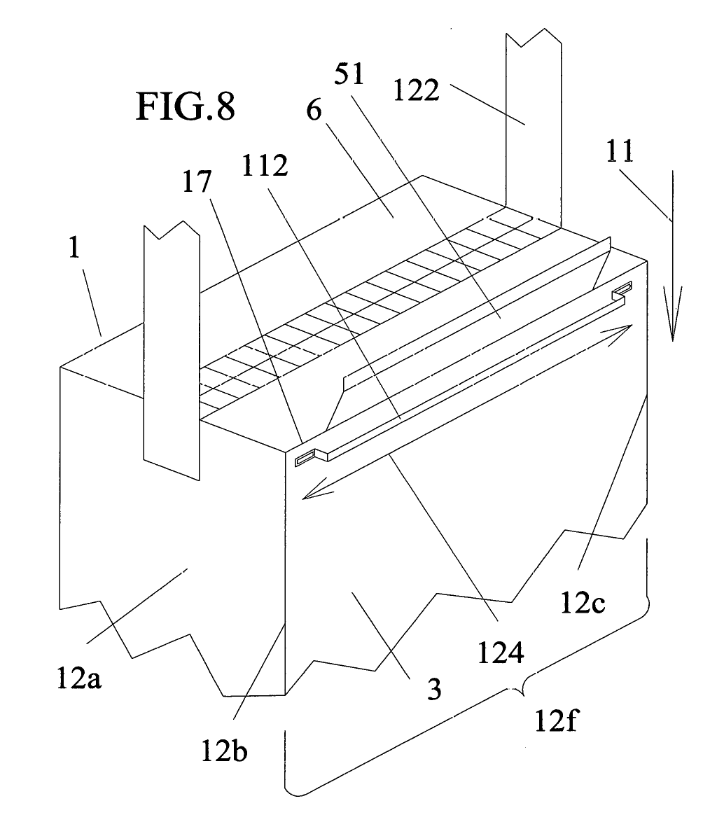

FIG. 8 shows the upward part of the bag 1 enlarged and with the display panel removed from the free section 51. All surfaces shown are outside surfaces of the bag and its walls. The free section is attached to the bag near the junction 17 of the top wall 6 of the bag and the front wall 3 of the bag. The bag strap 122 (cut short) is also shown. The vertical operating position holder 112 is shown attached across the outside surface of the bag front wall from near the bag right side 12b to near the bag left side 12c. The vertical operating position holder is shown attached to the outside surface of the bag front wall although it may, alternatively be attached elsewhere on the bag (for example, to a side wall 12a on the right side of the bag and/or to the side wall on the left side of the bag) so that the vertical operating position holder is positioned to pass laterally (right to left) across the bag front wall in a right to left lateral area 124 (approximated by the laterally oriented arrow running parallel to the top edge of the front wall, the display panel attachment edge and the attachment of the free section proximal end to the bag) so it is located in a downward 11 direction from the attachment of the free section to the bag. The vertical operating position holder may be located near the top end of the computer equipment storage area. The vertical operating position holder is shown as an elastic band attached on the right side of the bag and on the left side of the bag with the middle section of the band not attached to the bag and free to expand away from the bag and allow the display panel to be inserted between the vertical operating position holder and the bag. The vertical operating position holder is shown in this figure expanded away from the bag front ready for the display panel to be inserted. The location of the free section and vertical operating position holder relative to each other (free section upward and vertical operating position holder downward) allows the free section to move and operate freely except when display panel is between the vertical operating position holder and the bag front wall while in the vertical operating position. This figure also shows that the bag has width 12f in a right to left lateral direction (especially in the bottom end area) to provide for the operator body interface and lateral stability member.

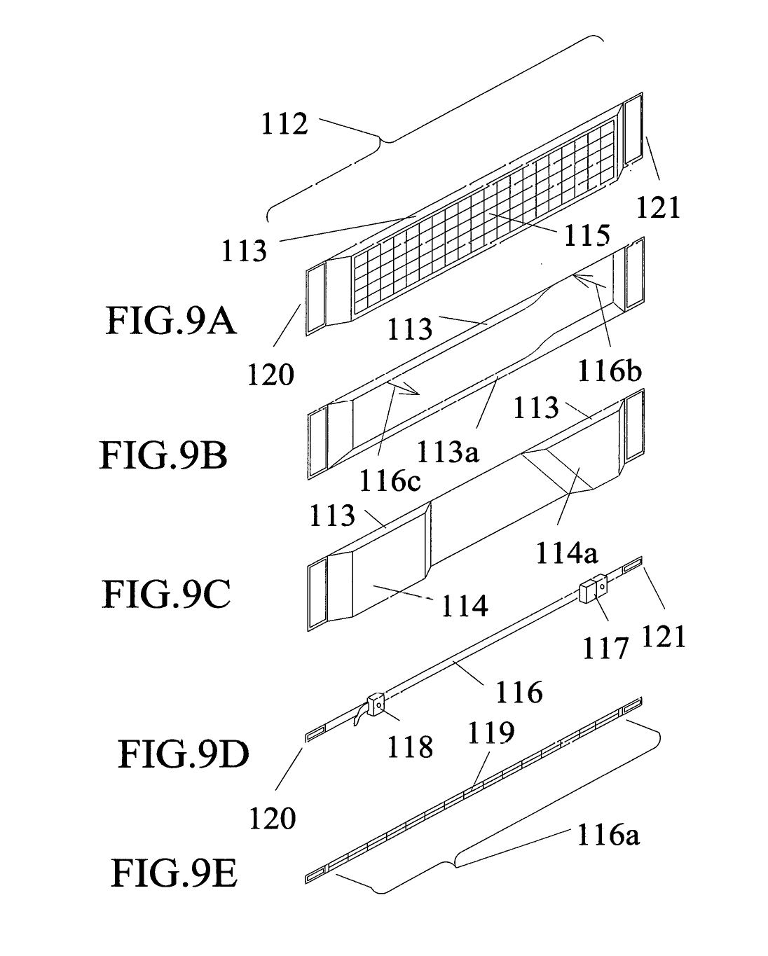

FIG. 9A, FIG. 9B, FIG. 9C, FIG. 9D and FIG. 9E show several possible variations of the vertical operating position holder 112. FIG. 9A shows that the holder, shown strip-like and extendable across the bag front wall, extends from a holder right end 120 (attachable near the bag right side) to a holder left end 121 (attachable near the bag left side). The top of the vertical operating position holder (upward direction part) may include a top opening 113 shaped to fit the display panel. The vertical operating position holder may include a contact surface 115. The contact surface is configured to provide an improved surface for the display panel extension prop end to contact and temporarily adhere to. For example, the contact surface may include a friction enhancing, material, surface or pattern such as elastomeric material, friction enhancing pattern, rigid or elastomeric projections, ribbing or other pattern to match the prop end; abrasive material or sticky material. When the display panel is not in a vertical operating position or in a storage position, the extension prop end may push against the contact surface and hold, without sliding or tipping, the display panel in an operating position angle relative to the bag front wall.

FIG. 9B shows that the vertical operating position holder may include an opening 113 shaped to fit the display panel and a holder bottom 113a to close the strip-like holder's bottom to form a pocket-like structure to fit the display panel. Such a structure may be attached (e.g. sewn or riveted) anywhere along the holder to the outside surface of the bag front wall instead of attaching just at the right end and left end and simple extending across it. The vertical operating position holder, whether including a bottom or not, may be configured to be collapsible 116b (contractible) (e.g. for storage against the bag front wall and not interfering with the movement, propping or storage of the display panel) or expandable 116c (e.g. for use in holding the display panel in a vertical operating position).

FIG. 9C shows that there may be more than one vertical operating position holder. The vertical operating position holder may be shaped to form one or more bands, one or more sockets 114a configured to hold the display panel extension prop, pockets, or receptacles 114 to hold, for example, extension props shaped like legs on the display panel. This structure may be attached (e.g. sewn or riveted) anywhere along a right to left lateral area located in a downward direction from the attachment of the free section to the bag and on the outside surface of the bag. These sockets, pockets or receptacles may be rigid or flexible.

FIG. 9D shows that the vertical operating position holder may be band-like 116 with no attachment to the bag between the holder (band) right end 120 and the holder (band) left end 121. The band may include a band release attachment 117 to open the band (i.e. separate a left section of the band from aright section of the band) for inserting the display panel and/or may include a band tightener 118 to adjust the length and/or tension of the band to optimize the hold of the band on the display panel.

FIG. 9E shows that the band may be made partially or entirely of elastic material 119 to allow the band to collapse (or contract as with elastic) or expand to fit the display panel. The elastic band may stretch away from the bag front wall to allow installation of the display panel into a vertical operating position between the band and the bag. The band may include a mid-section 116a not attached to the bag (front wall) and configured to fit the display panel between the holder (band) and the bag front wall. The mid-section may or may not be expandable or collapsible (contractible). The band may be made of rigid or semi-rigid material except for elastic sections near the holder (band) right end and holder (band) left end.

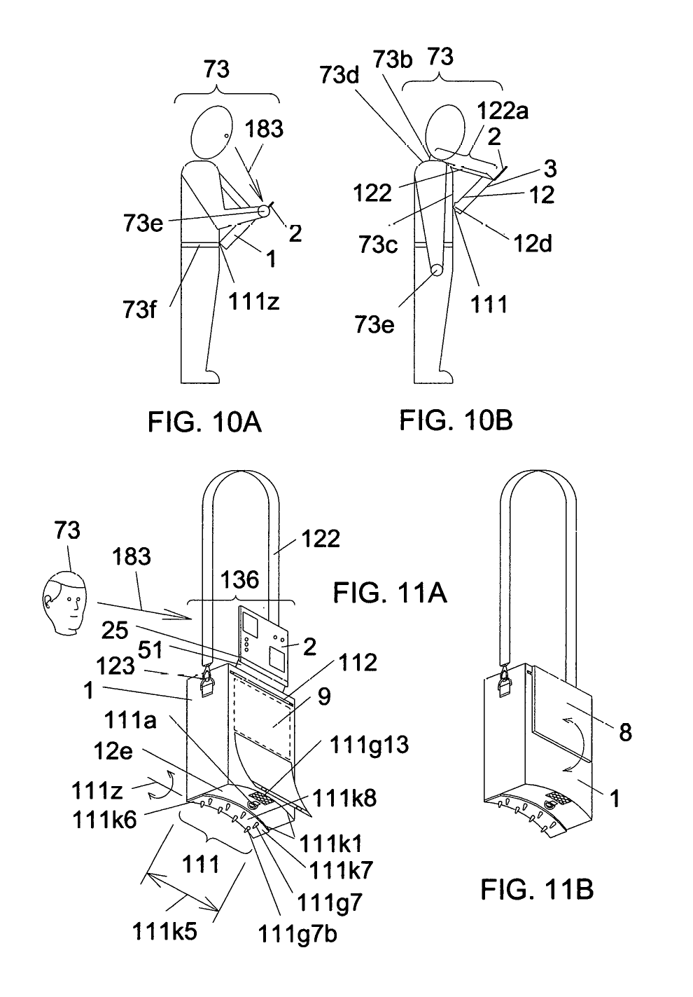

FIG. 10A shows a side view (profile) of the operator 73 (bag wearer) wearing, viewing and controlling the display panel 2 mounted to the top end area of the bag and viewable from in back of the bag and looking forward (back to front) over the top end area of the bag while the display panel is in a vertical operating position. The bag and display panel are shown in a vertical operating position. The operator is manipulating display panel manual controls with his hands 73e. The display panel 2 is in a vertical operating position and the bottom end area of the bag 1 is supported by the operator's (bag wearer's) body front surface area (chest stomach area). The bag may include an operator linking attachment on or near the bag bottom and configured to temporarily join to an intentional or incidental attachable object on the operator's body or clothing, in this case his belt 73f, to position the display panel further from the operator's body but closer to his face and/or more in line with the comfortable operator's view line of sight thus making the electronic display more easily viewed 183 from the back of the bag and over the top end area of the bag. The bag bottom end area, includes an operator body interface which has a lateral pivot axis 111z for adjusting the display distance from the face of the operator.

FIG. 10B is the same view as FIG. 10A but showing that the display panel 2 and bag may be supported by the operator's body (front stomach/chest surface area 73c) with the suspension device 122 (shown here as a strap) suspending the apparatus from the operator's neck 73b and/or shoulder 73d area without the operator using his hands 73e and without using any operator linking attachment between the bag and the operator. The apparatus may pivot (tip) on the operator's body at a lateral pivot axis (a part of the operator body interface) by adjusting the suspension device length 122a to optimize the distance between the operator's face and the display. The operator 73 is viewing the display from in back of the bag with the bag's back wall 12 closest to him. The bag's front wall 3 is on the bag side opposite the back side and further away from the operator. The bag bottom end area may include an operator body interface 111 to help support, stabilize and position the bag on the operator body front surface area to improve the operator's viewing of the bag's display panel while in a vertical operating position. The operator body interface may do this without an operator linking attachment by substituting a friction enhancing feature to increase the friction between the bag bottom end area and the operator's body front stomach/chest surface area and stop bag sliding in any direction. Thus, the bag's bottom end area and junction area of the back and bottom walls 12d, using the operator body interface, temporarily adheres to the operator's front stomach/chest surface area (sliding, stability) and provides lateral tipping stability while the suspension device suspends the bag from the operator's neck/shoulder area and the bag pushes the display into the comfortable operator's view line of sight over the top end of the bag without the need for him to use his hands.

FIG. 11A shows the bag (in an operating position) from a viewpoint that makes the bag bottom end area more visible. It can be seen that the bag 1 may include a bottom end area (including, for example, a bag bottom wall 12e) and a front wall with a computer equipment storage area 9 (for the display panel in storage position). The bag may include one or more suspension device attachments 123 and these may be located in a distal direction from the operator body interface in the bag bottom end area and toward the top end area of the bag and toward the right side and left side of the bag, for example, near the top wall right side and near the top wall left side. The bag may include a suspension device 122, such as (but not limited to) a strap or line, and this may be attached directly to the bag or may be attached to the bag via the suspension device attachments. The display panel 2 (back side visible) may be removably attached to the bag using a pivoting computer equipment mount, shown in this case as including a flexible fabric free section 51 to provide pivoting (hinging) capability so the display panel may pivot into and out of the computer equipment storage area. The bag (top end area) may have a bag part display panel mount, for example the free section part of the pivoting computer equipment mount, and the display panel may have a matching display panel part display panel mount, for example the display panel jaws of the pivoting computer equipment mount, located, for example, near the display panel attachment edge 25. These display panel mount parts may be arranged to position the display panel on the bag near the top end area 136 (in a vertical operating position) so the display is viewable by the operator (bag wearer) from in back of the bag and looking forward (back to front direction) over the top end area of the bag. Also shown in this figure is the vertical operating position holder 112, shown as an elastic band with its right end and left end attached to the bag on the bag right side and on the bag left side and free in its center section to expand away from the bag to allow installation (insertion) of the display panel (and free section) between the band and the bag front wall.

This figure also shows the outside surface of the bag's bottom end area (for example the bag 1 bottom wall 12e). Shown is an operator body interface 111 configured to temporarily hold the bottom end area of the bag to the operator so that the bag will not slide up or down or to the right side or to the left side and the bag's display may be viewed in a vertical operating position over the top of the bag's top wall from the back of the bag. Lateral tipping resistance may also be included because of the width of the bag's bottom end area provides for a lateral stability member 111k5 with two laterally separated surfaces. The bag bottom operator body interface features may be intended to temporarily attach the bag bottom end area to the operator and may include one or more operator linking attachment 111a such as (but not limited to) “D” rings, loops, straps, buttons, hooks or pockets (of metal; plastic or cloth), tabs and button holes, snaps, belt adapted operator linking attachment, clips, ties, hooks and loops, magnets or other attachments attachable to matching features or attachable to some incidental features on the operator's clothes (for example but not limited to a button, button hold, pocket or belt). The operator body interface or its components may be located on a nearby wall junction or adjacent wall (side, front, back) of the bag, the bag bottom or anywhere on the bag so that the bottom end area of the bag may be temporarily held to the operator.

The operator body interface may make the bag resist slipping in any direction. The interface and/or bag may resist tipping of the bag and display panel to the right or to the left of the operator and the display may be viewed in a more comfortable operator's 73 view line of sight 183 with the display panel in the vertical operating position in the bag top end area.

The bag bottom operator body interface may include stabilizing features intended to temporarily hold and stabilize the bag bottom end area to the operator. These stabilizing features may include (but not limited to) friction enhancing feature or gripping surfaces 111g13, legs or shaping 111k1 (for example, concave shaping to assure that the right laterally separated surface and left laterally separated surface contact the operator's body front) to compliment the operator's body to aid in temporarily adhering the bag bottom end area to the operator or to his clothing without the use of any attachment. A gripping surface may include materials that stick (such as (but not limited to) some sticky materials, elastomeric materials, sandpaper-like or abrasive coated materials), patterns that stick (such as (but not limited to) knurling, knobs, ribs, lugs, a grid and the like), rubber, elastomeric projections or rigid projections. Shaping or legs may increase lateral tipping stability and sliding stability by resisting lateral (right/left) tipping and sliding in all directions. Shaping may be in a concave way to help the operator body interface compliment the operator's front body surface and facilitate to contact of the friction enhancing feature to the operator.

This figure shows that the operator body interface 111 may include shaping 111k1 of the bag 1 bottom end area to better compliment the operator's body front stomach/chest surface area and resist slipping or tipping. The shaping of the bag bottom end area and/or the operator body interface may be concave (as shown) to match the shape of the operator stomach/check front area and resist lateral sliding and tipping. The bag bottom end area may include other operator body interface features such as (but not limited to) rigid or semi-rigid shaping 111k8 intended to hold the interface shape even with bag deformation from sagging or large load and may include width to serves as a lateral stability member. The operator body interface may include a friction enhancing feature such as a gripping surface and/or one or more rigid gripping projections 111g7 or elastomeric gripping projections 111g7b designed to use the bag's weight to enhance the friction between the bag bottom end area and the operator's body front stomach/chest surface area as the suspension device stays or suspends the bag and causes the bag bottom end area to push against and temporarily stick to the operator. These features of the operator body interface may be located in the bottom end area, for example, on back wall or bottom wall in the junction area of the back and bottom walls near the junction of the back and bottom walls. A friction enhancing feature, such as a gripping surface 111g13, may include (but not limited to) materials that stick (such as (but not limited to) some sticky materials, elastomeric materials, sandpaper-like or abrasive coated materials), patterns that stick (such as (but not limited to) knurling, knobs, ribs, lugs, a grid and the like), elastomeric, elastomeric projections or rigid projections. The operator body interface and/or bag bottom end area may include a lateral width to act as a lateral stability member 111k5 (extending in a right-left lateral direction) with two laterally separated surfaces (right laterally separated surface 111k6 and left laterally separated surface 111k7) to resist tipping of the bag and display panel to the right and to the left of the operator. The operator body interface and/or lateral stability member may form a lateral pivot axis 111z which may be located near the junction of the bag's back and bottom walls and allow the bag and display panel to pivot in a front to back and back to front direction to move the display toward or away from the operator's face with the adjustment of the suspension device length. Because of the flexible nature of the bag material, even a rigid operator body interface may pivot enough to adjust the interface to bag angle for good temporary adhesion to the operator yet to allow for pivoting (tipping) the bag and display panel in a front to back or back to front direction to optimize the display distance from the operator's face.

FIG. 11B shows the bag 1 computer in a storage position with the pivoting cover 8 pivoted over and covering the computer equipment storage area and any equipment in it.

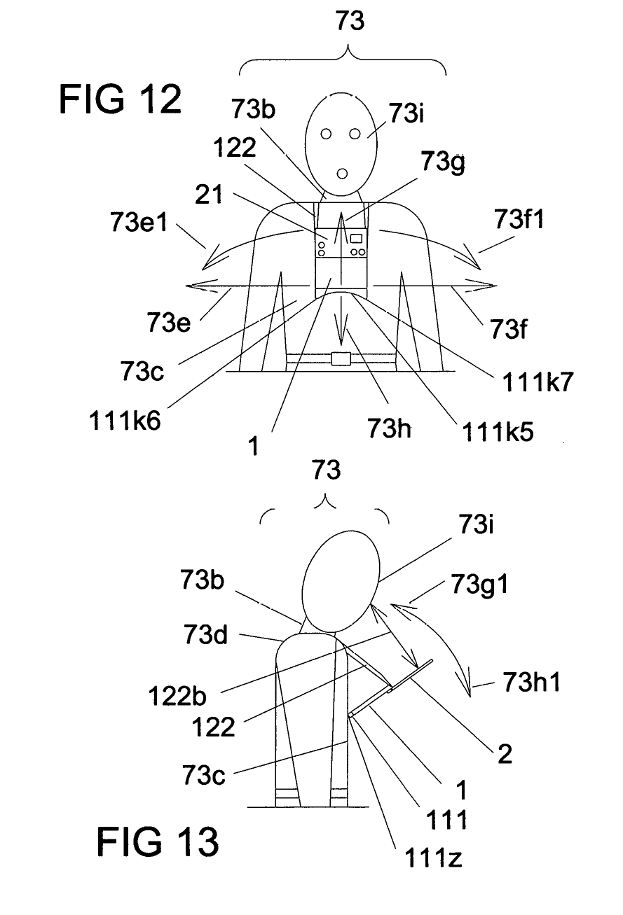

FIG. 12 and FIG. 13 show the stability characteristics of the bag including an operator body interface and display panel in a vertical operating position. In FIG. 12, the wearer's 73 (operator's) face 73i is facing forward (toward the application reader) with the bag with display panel in a vertical operating position with the suspension device 122 suspending the apparatus from his neck 73b. Visible is the display panel back side 21 including one or more manual controls and the bag 1. The operator is viewing the display on the front side of the display panel opposite the display panel back side. The operator body interface at the bottom end area of the bag is pushing against the operator's front stomach/chest area 73c. It can be seen that the operator body interface includes a width in a lateral direction (right/left direction) from the operator's body center front in a direction toward the operator's left side 73f and toward the operator's right side 73e. This lateral direction width of the operator body interface forms a lateral stability member 111k5 and includes a right laterally separated surface 111k6 and a left laterally separated surface 111k7, each of these two surfaces being contactable (engageable) with the operator's body (front stomach/chest area) to block tipping and provide lateral stability. Hence, the operator body interface width along with the downward direction distance of the laterally separated surfaces (as measured along the bag's vertical centerline) provides lateral direction (right/left) tipping stability because of the lateral direction width of the lateral stability member where it contacts (engages) the operator's body. This lateral direction tipping stability may be in terms of resisting or preventing the bag with display panel from tipping to the right 73e1 or tipping to the left 73f1. For this purpose, the lateral stability member may include or be tipping stability components such as (but not limited to) right and left interface legs, right and left prop rods, extended right bag side and extended left bag side especially in the bag bottom end area, concave shaping or shaping to compliment the operator's body.

Lateral direction stability may alternatively or additionally be provided by the operator body interface providing sliding stability in terms of the bag bottom end area resisting sliding on the operator's body to the right 73e or sliding to the left 73f. On the other hand, the operator body interface may provide sliding stability in an upward direction or downward direction in terms of the bag bottom end area resisting sliding on the operator's body upward 73g toward or sliding downward 73h away from the operator's face. As sliding stability components, one or more friction enhancing features and/or gripping surfaces may be included on the operator body interface to provide this sliding stability that resists sliding of the bag bottom end area in all directions on the operator's body surface.

FIG. 13 shows the operator 73 of FIG. 12 turned 90 degrees to the side (profile view). The display panel 2 is in front of the operator and pushed away from the operator's front stomach/chest surface area 73c by the bag 1. At or near the contact place between the operator body interface and the operator's front stomach/chest surface area the operator body interface 111 may be, include, create or be comprised of a lateral pivot axis 111z. This lateral pivot axis allows the bag and display panel to pivot in a back to front direction 73g1 and/or front to back direction 73h1 on the operator's body, for example on his body front stomach/chest surface area, as regulated by the suspension device length and to adjust the distance between the display and the operator's face. The suspension device 122 extends to or around the operator's neck 73b and/or shoulder 73d area to suspend the wearable bag apparatus and to provide stability in a back to front direction and/or front to back direction in terms of the display panel with bag tipping in a front to back direction 73g1 or tipping in a back to front direction 73h1 from the operator's face 73i. In this sense, the suspension device also provides a way to adjust the viewing distance 122b of the display toward 73g1 or away 73h1 from the operator's face.

The bag with operator body interface, display panel in vertical operating position, free section and vertical operating position holder along with the way it is used and its stability characteristics represents a method of use for a display panel propped by a bag against an operator's stomach/chest area and suspended by a suspension device from the operator's neck/shoulder area

1. A electronic display device for mobile use comprised of:
a. a bag comprise of a right side, a left side, a top end area and a front wall including an outside surface with a computer equipment storage area;
b. a display panel comprised of a front side with an electronic display, a back side, a connection end, an attachment edge and an extension prop;
c. a pivoting computer equipment mount pivotally attaching the display panel attachment edge to the bag near a top edge of the front wall wherein the pivoting computer equipment mount includes a free section attached to the bag and the display panel is pivotable from a storage position in the computer equipment storage area to an operating position including a vertical operating position; and
d. a vertical operating position holder attached to the bag in a right to left lateral area and extending from near a bag right side to near a bag left side and located in a downward direction from the attachment of the free section to the bag wherein the vertical operating position holder is configured to hold the connection end to the bag with the display panel in a vertical operating position and the electronic display is viewable by an operator over the top end area.

2. The display device of claim 1 wherein the vertical operating position holder is a band attached to the bag near the bag right side and near the bag left side with a mid-section expandable away from the bag front wall.

3. The display device of claim 2 wherein the band includes of elastic material.

4. The display device of claim 2 wherein the band is further comprised of one of a band release attachment and a band tightener.

5. The display device of claim 1 wherein the vertical operating position holder is includes a bottom and is a pocket.

6. The display device of claim 1 wherein the vertical operating position holder is shaped into one or more sockets configured to hold the display panel.

7. The display device of claim 1 wherein the vertical operating position holder is configured to be collapsible and expandable.

8. The display device of claim 1 wherein the vertical operating position holder is further comprised of a contact surface.

9. The display device of claim 1 further comprised of a pivoting cover attached to the bag, wherein the cover is pivotable from a storage position covering the computer equipment storage area to an operating position exposing the computer equipment storage area.

10. A bag for holding an electronic display panel for mobile use, the bag comprised of:
a. a bag comprise of a right side, a left side, a top end area and a front wall including an outside surface with a computer equipment storage area;
b. a pivoting computer equipment mount configured to pivotally attaching the electronic display panel to the bag near a top edge of the front wall wherein the pivoting computer equipment mount includes a free section attached to the bag and configured to pivot the electronic display panel from a storage position in the computer equipment storage area to an operating position including a vertical operating position; and
c. a vertical operating position holder attached to the bag in a right to left lateral area and extending from near the bag right side to near the bag left side and located in a downward direction from the attachment of the free section to the bag wherein the vertical operating position holder is configured to hold a connection end of the display panel to the bag with the display panel in a vertical operating position and viewable by an operator over the top end area.

11. The bag of claim 10 wherein the vertical operating position holder is a band attached to the bag near the bag right side and near the bag left side with a mid-section expandable away from the bag front wall.

12. The bag of claim 11 wherein the band includes elastic material.

13. The bag of claim 11 wherein the band is further comprised of one of a band release attachment and a band tightener.

14. The bag of claim 10 wherein the vertical operating position holder is includes a bottom and is a pocket.

15. The bag of claim 10 wherein the vertical operating position holder is shaped into one or more sockets configured to hold the display panel.

16. The bag of claim 10 wherein the vertical operating position holder is configured to be collapsible and expandable.

17. The bag of claim 10 wherein the vertical operating position holder is further comprised of a contact surface.

18. The bag of claim 10 further comprised of a pivoting cover attached to the bag, wherein the cover is pivotable from a storage position covering the computer equipment storage area to an operating position exposing the computer equipment storage area.
